(19) United States
(12) Patent Application Publication
(10) Pub. No.: US 2022/0043231 A1
(43) Pub. Date: Feb. 10, 2022

(54) OPTICAL LENS, LENS MODULE HAVING OPTICAL LENS, AND ELECTRONIC DEVICE

(71) Applicant: HON HAI PRECISION INDUSTRY CO., LTD., New Taipei (TW)

(72) Inventors: PO-CHOU CHEN, Tu-Cheng (TW); CHUN-CHENG KO, New Taipei (TW)

(21) Appl. No.: 17/135,314

(22) Filed: Dec. 28, 2020

(30) Foreign Application Priority Data
Aug. 6, 2020 (CN) 202010781439.8

(51) Int. Cl. G02B 7/02; G02B 13/00; G03B 17/12; G02B 1/06

(52) U.S. Cl. CPC G02B 7/021; G02B 1/06; G03B 17/12; G02B 13/0035

(57) ABSTRACT

An optical lens includes a first transparent portion and a first flange portion arranged around the first transparent portion. The first transparent portion and the first flange portion are symmetrical about an optical axis of the optical lens. The first flange portion includes a connecting portion and a peripheral portion. The connecting portion is coupled between the first transparent portion and the peripheral portion. An object side of the first transparent portion includes a first transparent surface. The connecting portion includes a connecting surface coupled to the first transparent surface. The connecting surface is a textured surface.

### FIELD

The subject matter herein generally relates to lens modules, and more particularly to an optical lens of a lens module.

### BACKGROUND

Generally, a lens module sets a light shield between two adjacent lenses to eliminate or reduce stray light, thereby reducing glare. However, there is no light shield behind the lens closest to the image side, and a portion of stray light may reflect off a flange of the lens, which will cause glare.

### BRIEF DESCRIPTION OF THE DRAWINGS

Implementations of the present disclosure will now be described, by way of embodiments, with reference to the attached figures.

FIG. 1 is a schematic diagram of an embodiment of a lens module.

FIG. 2 is a schematic diagram of an embodiment of an optical lens shown in FIG. 1.

FIG. 3 is a schematic diagram of an electronic device having the lens module in FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

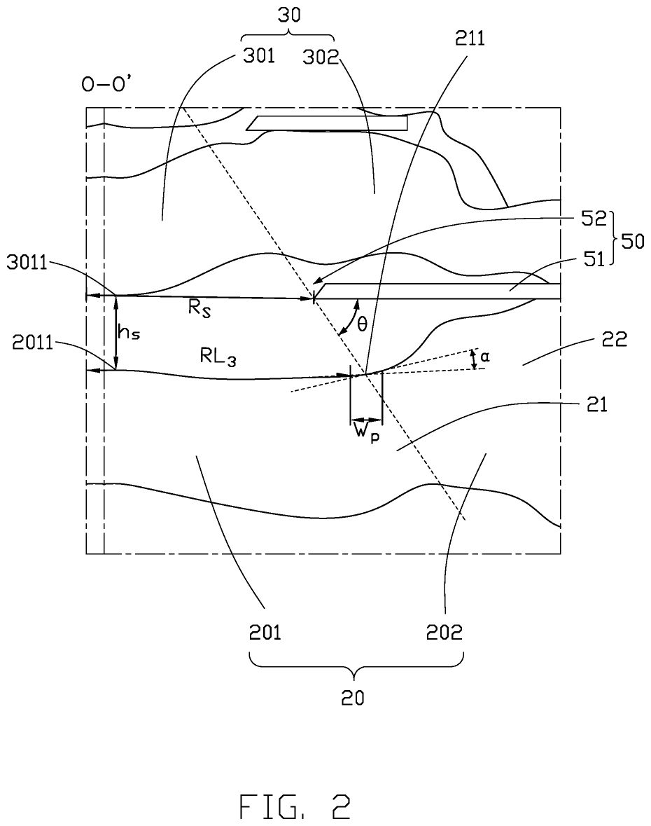

As shown in FIG. 2, an optical lens 20 having an optical axis 00′ includes a first transparent portion 201 and a first flange portion 202 arranged around the first transparent portion 201. Both the first transparent portion 201 and the first flange portion 202 are symmetrical about the optical axis OO′.

The first flange portion 202 includes a connecting portion 21 and a peripheral portion 22. The connecting portion 21 is coupled between the first transparent portion 201 and the peripheral portion 22. An object side of the first transparent portion 201 includes a first transparent surface 2011. The connecting portion 21 includes a connecting surface 211 coupled to the first transparent surface 2011. The connecting surface 211 is a textured surface to diffuse stray light incident on the connecting surface 211, thereby reducing glare.

A surface angle of the connecting surface 211 is defined as α, and α is greater than 10°.

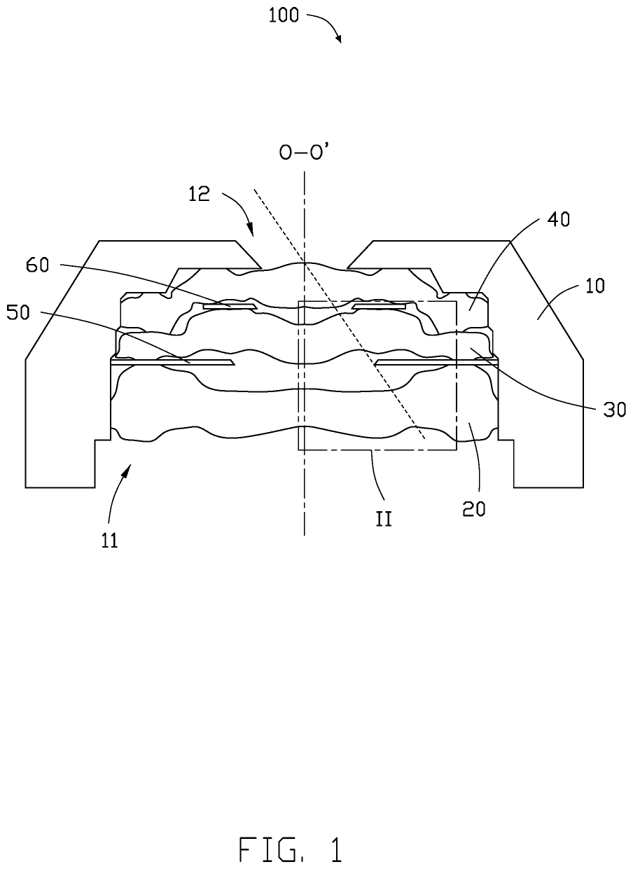

As shown in FIG. 1, an lens module 100 includes a lens barrel 10 and a plurality of lenses received and fixed in the lens barrel 10. At least one of the lenses is the optical lens 20 as described above. In one embodiment, the optical lens 20 is the lens located closest to an image side.

In one embodiment, the plurality of lenses include a first lens 20, a second lens 30, and a third lens 40 housed and fixed in the lens barrel 10. The first lens 20, the second lens 30, and the third lens 40 are sequentially housed and fixed in the lens barrel 10 from the image side to the object side, and the first lens 20 is the optical lens 20 as described above in FIG. 2.

The lens barrel 10 defines a receiving cavity 11 and a light entrance 12. The light entrance 12 communicates with the receiving cavity 11. An inner diameter of the light entrance 12 is smaller than an inner diameter of the receiving cavity 11. The first lens 20, the second lens 30, and the third lens 40 are sequentially housed and fixed in the housing cavity 11 from the image side to the object side. The third lens 40 is adjacent to the light entrance 12.

The second lens 30 further includes a second transparent portion 301 and a second flange portion 302 arranged around the second transparent portion 301. The second transparent portion 301 faces the first transparent portion 201, and the second flange portion 302 faces the first flange portion 202. The second transparent portion 301 includes a second transparent surface 3011 facing the first transparent surface 2011.

In one embodiment, the lens module 100 further includes a first light shield 50 and a second light shield 60. The first light shield 50 is located between the first lens 20 and the second lens 30, and the second light shield 60 is located between the second lens 30 and the third lens 40.

The first light shield 50 includes a main body 51 and defines a hole 52 surrounded by the main body 51. The hole 52 faces the first transparent portion 201.

A width of the connecting surface 211 is greater than Wp, and Wp satisfies the following relationship: Wp=2×(hₛ×tanθ+Rs−RL3), wherein θ is a half-field angle, Rs is a radius of the hole 52 of the first light shield 50, RL3 is a radius of the first transparent portion 201, and hₛ is a distance between the first transparent surface 2011 and the second transparent surface 3011 along the optical axis OO′.

In other embodiments, the lens module 100 may further include more lenses and light shields, as long as the lens closest to the image side is the optical lens 20 as described above.

In other embodiments, the lens module 100 may not include the first light shield and the second light shield. In this case, all of the lenses are the same as the optical lens 20.

In one embodiment, the lens module 100 further includes a filter (not shown), a photosensitive element (not shown), and a circuit board (not shown).

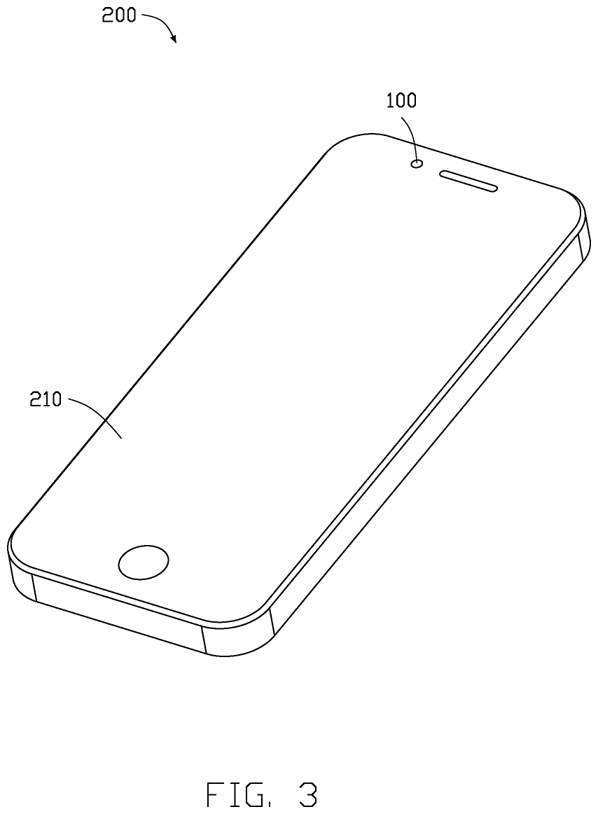

Referring to FIG. 3, an electronic device 200 includes a body 210. The electronic device 200 further includes at least one lens module 100 as described above arranged in the body 210.

The optical lens 100 provided by the present disclosure is provided with the connecting surface 211. By designing the texture, width, and surface angle of the connecting surface 211, a portion of light incident on the connecting surface 211 can be bent outward or totally reflected, and then absorbed by the lens barrel 10. In this way, glare can be further reduced, and an imaging quality of the optical lens can be improved.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An optical lens comprising:
a first transparent portion; and
a first flange portion arranged around the first transparent portion; wherein:
the first transparent portion and the first flange portion are symmetrical about an optical axis of the optical lens;
the first flange portion comprises a connecting portion and a peripheral portion;
the connecting portion is coupled between the first transparent portion and the peripheral portion;
an object side of the first transparent portion comprises a first transparent surface;
the connecting portion comprises a connecting surface coupled to the first transparent surface; and
the connecting surface is a textured surface.

2. The optical lens of claim 1, wherein:
a surface angle of the connecting surface is greater than 10°.

3. A lens module comprising:
a lens barrel; and
a plurality of lenses housed and fixed in the lens barrel, at least one of the plurality of lenses being an optical lens comprising a first transparent portion and a flange portion arranged around the transparent portion, wherein:
the first transparent portion and the first flange portion are symmetrical about an optical axis of the optical lens;
the first flange portion comprises a connecting portion and a peripheral portion;
the connecting portion is coupled between the first transparent portion and the peripheral portion;
an object side of the first transparent portion comprises a first transparent surface;
the connecting portion comprises a connecting surface coupled to the first transparent surface;
the connecting surface is a textured surface; and
the optical lens is located closest to an image side among the plurality of lenses.

4. The lens module of claim 3, wherein:
the plurality of lenses comprises the optical lens, a second lens, and a third lens sequentially housed and fixed in the lens barrel from the image side to the object side.

5. The lens module of claim 4, further comprising a first light shield, wherein:
the first light shield is located between the first lens and the second lens.

6. The lens module of claim 5, wherein:
the first light shield comprises a main body and defines a hole surrounded by the main body; and
the hole faces the first transparent portion.

7. The lens module of claim 6, wherein:
the second lens comprises a second transparent portion facing the first transparent portion;
the second transparent portion comprises a second transparent surface facing the first transparent surface;
a width of the connecting surface is greater than Wp, and Wp satisfies the following relationship: Wp=2×(hₛ×tanθ+Rs−RL3);
θ is a half-field angle;
Rs is a radius of the hole of the first light shield;
RL3 is a radius of the first transparent portion; and
hₛ is a distance between the first transparent surface and the second transparent surface along the optical axis.

8. The lens module of claim 5, further comprising a second light shield, wherein:
the second light shield is located between the second lens and the third lens.

9. The lens module of claim 8, wherein:
the lens barrel defines a receiving cavity and a light entrance;
the light entrance communicates with the receiving cavity;
the optical lens, the first light shield, the second lens, the second light shield, and the third lens are sequentially housed and fixed in the housing cavity from the image side to the object side; and
the third lens is adjacent to the light entrance.

10. An electronic device comprising:
a body; and
a lens module comprising:
a lens barrel; and
a plurality of lenses housed and fixed in the lens barrel, at least one of the plurality of lenses being an optical lens comprising a first transparent portion and a flange portion arranged around the transparent portion, wherein:
the first transparent portion and the first flange portion are symmetrical about an optical axis of the optical lens;
the first flange portion comprises a connecting portion and a peripheral portion;
the connecting portion is coupled between the first transparent portion and the peripheral portion;
an object side of the first transparent portion comprises a first transparent surface;
the connecting portion comprises a connecting surface coupled to the first transparent surface;
the connecting surface is a textured surface; and
the optical lens is located closest to an image side among the plurality of lenses.

11. The electronic device of claim 10, wherein:
the plurality of lenses comprises the optical lens, a second lens, and a third lens sequentially housed and fixed in the lens barrel from the image side to the object side.

12. The electronic device of claim 11, further comprising a first light shield, wherein:
the first light shield is located between the first lens and the second lens.

13. The electronic device of claim 12, wherein:
the first light shield comprises a main body and defines a hole surrounded by the main body; and
the hole faces the first transparent portion.

14. The electronic device of claim 13, wherein:
the second lens comprises a second transparent portion facing the first transparent portion;
the second transparent portion comprises a second transparent surface facing the first transparent surface;
a width of the connecting surface is greater than Wp, and Wp satisfies the following relationship: Wp=2×(hₛ×tanθ+Rs−RL3);
θ is a half-field angle;
Rs is a radius of the hole of the first light shield;
RL3 is a radius of the first transparent portion; and
hₛ is a distance between the first transparent surface and the second transparent surface along the optical axis.

15. The electronic device of claim 14, further comprising a second light shield, wherein:
the second light shield is located between the second lens and the third lens.

16. The electronic device of claim 15, wherein:
the lens barrel defines a receiving cavity and a light entrance;
the light entrance communicates with the receiving cavity;
the optical lens, the first light shield, the second lens, the second light shield, and the third lens are sequentially housed and fixed in the housing cavity from the image side to the object side; and
the third lens is adjacent to the light entrance.
